(19) United States
(12) Patent Application Publication
(10) Pub. No.: US 2002/0019904 A1
(43) Pub. Date: Feb. 14, 2002

(54) Three-dimensional switch providing packet routing between multiple multimedia buses

(76) Inventor: Abraham Yehuda Katz, Karmiel (IL)

Correspondence Address: BROWDY AND NEIMARK, P.L.L.C., 624 NINTH STREET, NW, SUITE 300, WASHINGTON, DC, 20001-5303, US

(21) Appl. No.: 09/853,027

(22) Filed: May 11, 2001

Related U.S. Application Data
(60) Provisional application No. 60/203,580, filed on May 11, 2000.

(51) Int. Cl. G06F 13/00

(52) U.S. Cl. 710/316

(57) ABSTRACT

A method and data a network for routing data packets is described. Switches are connected in a three-dimensional architecture (11) to form a switching fabric providing horizontal data routing according to addresses and vertical data routing according to packet types. An allocation procedure is then executed to manage the bandwidth resources of said fabric, resulting with assigning routing tables at the switches and portals prior to forwarding the packets to the switch fabric, a hop-by-hop packet flow is then executed through said switches of said switch fabric. Packet flow is controlled by an output port having an output port state machine and an output port concentrator.

### FIELD OF THE INVENTION

The present invention relates to the integration of three-dimensional switches for use in data routing in digital pack networks. The present invention is particularly applicable to packet routing between multiple multimedia buses for support of multimedia data stream transmission such as audio and video data streams in a timely manner.

### BACKGROUND TO THE INVENTION

In data communication networks, data packets are transmitted from a source node to a receiver node. Upon receipt, packets are checked for correctness and then acknowledged. In the event of an error, packets are retransmitted resulting in an unordered packet stream. The receiving node reorders and reassembles the packets:to reconstitute the original data, In traditional data communication networks, the emphasis has been to ensure that complete and correct data is eventually received at the receiver node. Whilst the timing and receipt order of packets is not seen as critical, obviously the faster and more ordered the received series of packets is, the better. Switching fabrics for traditional networks such as Ethernet and ATM are well known in the art. Recently, additions to these traditional switching fabrics permit quality of service to be supported, thereby achieving a guaranteed average rate of transmission of packets.

However, in the case of multimedia data streams, the ordering and timing of constituent packets in a received data stream is critical. Therefore, there is demand for stream transport and corresponding fabrics that are able to guarantee transfer of packets in a timely manner, (normally a guaranteed packet transfer each clock cycle). For example, the requirements may be that a packet transfer is guaranteed to occur every 125 micro seconds. There may be a further requirement for low latency between source and receipt nodes. For high quality multimedia traffic, clocks within all nodes within the data so network may need to be synchronised (i.e. have the same frequency).

Current switching systems and corresponding algorithms do not guarantee packet transfer at all, nor do they guarantee packet transfer in a timely manner. Therefore, large buffers must be used in combination with deliberately introduced latency to achieve high quality video streaming. The buffers; and latency are used to give a receiving node time the ability to control packet time jitter. Clock synchronisation is rarely supported and synchronizing the clocks on each node is an extremely complicated task.

There exist multimedia buses designed to support asynchronous and isochronous protocols Such buses typically have an arbitration scheme to support the two protocols. The buses guarantee isochronous packet transfer by managing both bandwidth and resources. As the bus is completely in control of the communications medium (itself), guaranteed timely packet delivery is possible. However, hardware limitations means that buses can only support short distance connections and the number of connected devices along a bus is limited. Furthermore, in contrast to a network, a bus can only allow one source to transmit data at any one time.

There is thus a widely recognised need for, and it would be highly advantageous to have, a method of routing data packets through a switch allowing concurrent asynchronous and isochronous packet routing with the ability to prioritise certain data packets. In particular, accepted isochronous data packets must be routed with priority to ensure no blockage or delay. There is a corresponding need, and it would be highly advantageous to have a data communication network that implements the said method.

### STATEMENT OF THE INVENTION

According to a first aspect of the present invention, there is provided a method for routing data packets through a switch fabric connecting a plurality of broadband buses, said switch fabric containing a plurality of switches each with several ports and having interconnections between them, the switch fabric being connected to said buses sing portal devices, the method comprising:

(a) connecting switches in a three-dimensional architecture providing horizontal data routing according to addresses and vertical data routing according to packet types;

(b) executing an allocation procedure to manage the bandwidth resources of said fabric resulting with assigning routing tables at the switches and portals;

(c) encapsulating packets prior to forwarding to the switch fabric; and,

(d) executing a hop-by-hop packet flow through said switches of said switch fabric, said packet flow controlled by an output port with an output port state machine and an output port concentrator

The present invention seeks to provide a switching fabric system and method capable of bridging and connecting together a number of multimedia buses. The switching fabric system supports the following tasks and features, among others:

(a) support of asynchronous and isochronous protocols:

(b) avoidance of data transfer blockages during operation;

(c) guarantee data packet delivery with no packet loss;

(d) guarantee isochronous packet delivery in a timely manner;

(e) avoidance of data congestion over the switching fabric;

(f) automatic system configuration;

(g) frequency synchronisation over all buses within the switching fabric;

(h) support of variable fame size up to 2Kbytes;

(i) assignment of channel numbers for isochronous streams, each channel being assigned an optimal channel route;

(j) routing isochronous data packets by channel instead of by destination address; and,

(k) support of unicast, multicast and broadcaster data packets.

In particular, the present invention relates to a packet flow control management system and the related data flow control and routing method over the switching fabric.

Packet flow may be controlled by said output port state machine, a RQRS protocol and a MLIP protocol.

The method may further comprise: executing a RQRS protocol for negotiating a primary packet transfer, sad RQRS protocol comprising the steps of.

(a) selecting at a switch output port a primary packet to be transferred and generating a fabric request data packet;

(b) transferring the fabric request-packet over the switching fabric to an adjacent input port;

(c) determining acceptability of the fabric request and generating a fabric response packet indicating grant or denial of the request; and,

(c) transmitting said fabric response packet back to the originating switch and inputting the denial or grant of said selected packet to the output port state machine.

The method may further comprise: executing said MLIP protocol for sharing a connection, CIO, between a plurality of packets, said MLIP protocol comprising the steps of:

(a) receiving data at input ports while transmitting a packet;

(b) checking for interrupt conditions while transmitting;

(c) in the event of interrupt conditions, ceasing transmission of the current packet, transmitting a control character indicating end of transmission, storing necessary data needed to subsequently resume the transmission, and starting negotiating a new packet transfer under said RQRS protocol; and

(d) upon ending a packet transmission, checking if an interrupted packet is awaiting completion and resuming transmission of any interrupted packet.

The output port concentrator may select the next packet to be forwarded from the output memory, comprising:

(a) selecting a new packet to be transferred if:

(i) said output port is in idle state and at least one packet is ready for transmission; and

(ii) said output port is currently in transmission state while a new packet has arrived in full, and interrupt conditions are met;

(b) selecting the packet to be transferred according to parameters selected from the group including a layer priority when higher layer equals higher priority, a rejection number, a queue size, and natural priority; and

(c) starting said RQRS protocol process utilising a switch timer for the management of said selected packet's denials.

According to a second aspect of the present invention, there is provided a computer readable medium, on which is stored a computer program of instructions for controlling a general purpose computer to route data packets in a switch fabric between a plurality of broadband buses to a switch fabric, the switch fabric containing a plurality of switches each with several ports and having interconnections between them, the switch fabric being connected to said buses using portal devices, comprising in combination: means for connecting the switches in a three-dimensional architecture providing horizontal data routing according to addresses and vertical data routing according to packet types;

means for executing an allocation procedure to manage the bandwidth resources of said fabric resulting with assigning routing tables at the switches and portals;

means for encapsulating packets prior to forwarding to the switch fabric; and, means for executing a hop-by-hop packet flow through said switches of said switch fabric; and,

means for controlling packet flow from an output port with an output port state machine and an output port concentrator.

The computer readable medium may further comprise means for controlling packet flow by said output port state machine a RQRS protocol and a MLIP protocol.

The computer readable medium may further comprise means for executing a RQRS protocol for negotiating a primary packet transfer, comprising:

means for selecting at a switch output port a primary packet to be transferred and generating a fabric request data packet;

means for transferring the fabric request packet over the switching fabric to an adjacent input port;

means for determining acceptability of the fabric request and generating a fabric response packet indicating grant or denial of the request; and,

means for transmitting said fabric response packet back to the originating switch and inputting the denial or grant of said selected packet to the output port state machine.

The computer readable medium may further comprise means for executing said MLIP protocol for sharing a connection, CIO, between a plurality of packets, comprising:

means for receiving data at input ports while transmitting a packet;

means for upon receipt of a full packet at an input port checking for interrupt conditions;

means for detecting the event of interrupt conditions, ceasing transmission of the current packet, transmitting a control character indicating end of transmission, storing necessary data needed to subsequently resume the transmission, and string negotiating a new packet transfer under said RQRS protocol; and

means for upon ending a packet transmission, checking if an interrupted packet is awaiting completion and resuming, transmission of any interrupted packet.

The output port concentrator may select the next packet to be forwarded from the output memory, selection being performed by:

means for selecting a new packet to be transferred if:

(i) said output port is in idle state and at least one packet is ready for transmission; and

(ii) said output port is currently in transmission state while a new packet has arrived in fall, and interrupt conditions are met;

means for selecting the packet to be transferred according to parameters selected from the group including a layer priority when higher layer equals higher priority, a rejection number, a queue size, and natural priority; and

means for starting said RQRS protocol process utilising a switch timer for the management of said selected packet's denials.

According to another aspect of the present inventions there is provided a switching fabric connected in a three-dimensional architecture providing horizontal data routing according to addresses and vertical data routing according to packet types, the switch fabric including a plurality of input and output ports for connection to a bus or other network traffic carriers.

Output ports of at least some of the switches may be connected to an input port of another switch to form the three-dimensional architecture.

Each switch may have a numeric identifier n, wherein the nth input and output of the switch is reserved for transmission and receipt of switch fabric routing packets,

The switching fabric may further comprise a concentrator connected to at least some of the output ports of at least some of the switches, the concentrator being arranged to select the next packet to be forwarded from the output ports to exit the switching fabric.

According to a further aspect of the present invention, there is provided a data communications network including switching fabric system inter-connecting a plurality of buses and facilitating inter bus isochronous and asynchronous data communication, the plurality of buses being connected to said switching fabric via portal devices, the switching fabric comprising a plurality of switches interconnected by a three dimensional array of CIO connections, the network further comprising a network management node for data flow control for transferring packets from one of said buses to at least one of a plurality of said buses, thereby enabling unicast, multicast and broadcast of data packet transfer.

Preferably, each of said switches is a three-dimensional switch having an output port memory organisation to support said infer-bus data communication Preferably, each bus is a multimedia broadband bus of the IEEE 1394 type.

### BRIEF DESCRIPTION OF THE DRAWINGS

An example of the present invention will now be described in detail, with reference to the accompanying drawings, in which:

FIG. 1 is a schematic diagram of a multimedia switching fabric according to one aspect of the present invention;

FIG. 2 is a high level schematic diagram illustrating the architecture of a switch according to FIG. 1;

FIG. 3 is a schematic diagram illustrating one layer of switching circuitry of the switch of FIG. 2;

FIG. 4 illustrates a single output port queue arrangement used in tie present invention;

FIG. 5 is a channel input output local loop demonstrating fabric request packet flow;

FIG. 6 is a schematic diagram illustrating a fabric request packet format;

FIG. 7 is a flow chart illustrating the operation of The RQRS protocol.

FIG. 8 is a schematic diagram illustrating the operation of an output port state machine; and,

FIG. 9 is a flow chart illustrating the operation of an output port concentrator algorithm.

### DETAILED DESCRIPTION

In the present invention, a switched fabric connects several multimedia buses such as IEEE-1394 buses. The following describes a method for determining an optimal route for stream requests and management of the fabric bandwidth in an optimal way in accordance with the present invention. Allocation of each stream channel (for example, audio and video data stream signals) is performed via a negotiation process.

Throughout the following description a number of technical terms are used, the meanings of which are known to the skilled reader but provided below for reasons of clarity:

SWITCH—electronic circuitry capable of directing received data to none, a selection or all of its outputs.

MULTIPLEXER—electronic circuitry capable of directing one input to one of many different outputs.

FIFO—(First in First out) a memory organization in which the first word written to the memory is the first to be read.

QUEUE—a FIFO memory used for storage of several packets organized by order of arrival.

CIO—channel input output, also known as a point to point connection. A connection between two switches or between a switch and a portal.

UNICAST—a data communication between a single source and a single destination.

MULTICAST—a data communication between a single source and multiple destinations.

BROADCAST—a data communication between a single source and all destinations.

ISOCHRONOUS PACKET—a packet routed by channel number. Isochronous packets are transmitted at predetermined clock frequency. In each time cycle, one packet has to be delivered.

ASYNCHRONOUS PACKET—a packet routed by destination address. Asynchronous packet delivery is given lower priority than isochronous packet delivery. Delivery timing of asynchronous packets is not frequency limited and is frequently on a best effort basis.

PRIMARY PACKET—a packet that is originated in a multimedia bus. Allowable packet types are: asynchronous request packet, asynchronous response packet and isochronous packet.

SWITCH FABRIC PACKET—a packet generated in the switch fabric output ports used to negotiate a primary packet transfer.

STATE MACHINE—describes the logical behaviour of a machine. Each state has its actions and conditions to move to the other states.

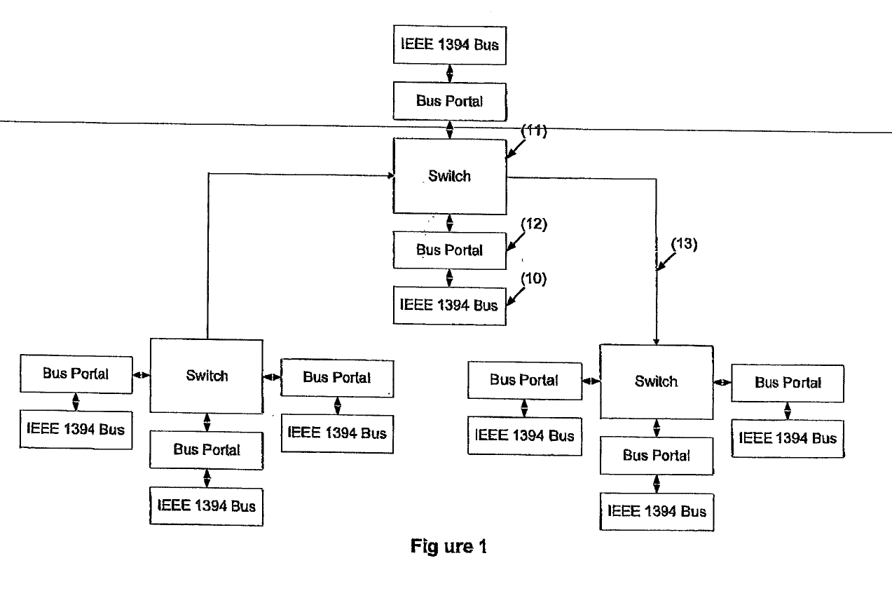

FIG. 1 is a schematic diagram of a possible switch fabric for use in the present invention. However, switch fabrics can be as large as required and any connection structure is permitted. A number of switches 11 are connected together. The switch fabric connects buses via IEEE-1394 bus portal devices 12. Both IEEE-1394 buses 10 and bus portal 12 are well known to the skilled reader. A channel input output 13 (CIO) is the physical connection between a switch 11 and a bus portal device 12 or between two switches 11. A channel can carry data and control data movement in both directions (full duplex). A channel may be constructed from one or more of data carrier media, such as:

1. fibre optic cables.

2. coaxial cables.

3. UTP unshielded twisted pair or STP (shielded twisted pair) cables.

4. Wireless connection (such as electromagnetic radiation).

In the event of any fabric topology change or during power up, the switching fabric is reinitialised. The initialisation process includes:

1. selection of a network manager from one of the available switching devices in the network.

2. collection of network topology data by the network manager.

3. initialisation of routing tables.

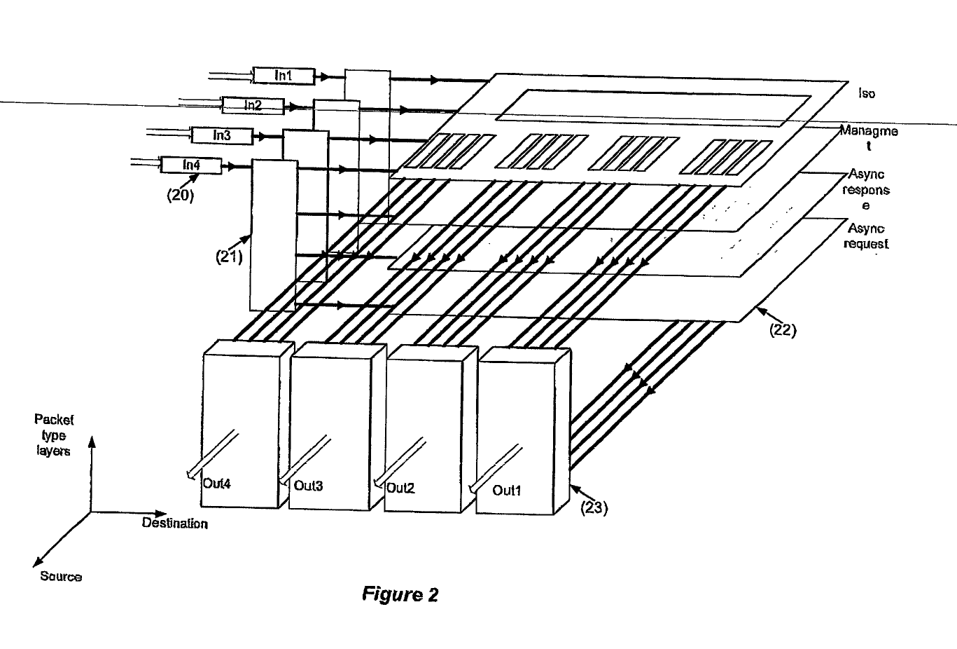

FIG. 2 is a high level schematic diagram illustrating the architecture of a switch according to FIG. 1. The switch is formed in three dimensions, the first dimension being dependent on the source of a data packet, the second dimension being dependent on the destination of a data packet and the third dimension being dependent on the data packet type.

Each input port is a small FIFO (First in First out memory organization) buffer 20 for storing the incoming packets. Packets received at a FIFO buffer 20 are treated differently depending on the their type. If the incoming packet is an IEEE1394 primary packet it is routed to an appropriate layer 22 according to its type selected from the group including: Asynchronous Request packet, Asynchronous Response Packet and Isochronous Packet. If the packet is a fabric protocol packet it is processed and the processing result is routed to the adjacent output port. That is, if the fabric protocol packet was received in port K input buffer it will be written to a buffer specially reserved in the K output port. All input routing is done by one or more multiplexers 21.

Each layer 22 is a switching device in its own right capable of routing a message from any given input port that layer to any given output port on that layer according to a routing table. The network manager is responsible for maintaining the routing tables throughout the switching devices. Asynchronous packet routing is determined and written to the routing tables during initialisation while routing data for isochronous streams is written to the routing tables wing allocation of the stream resources. Other than maintenance of the routing tables, the network manger takes no further part in the packet flow process.

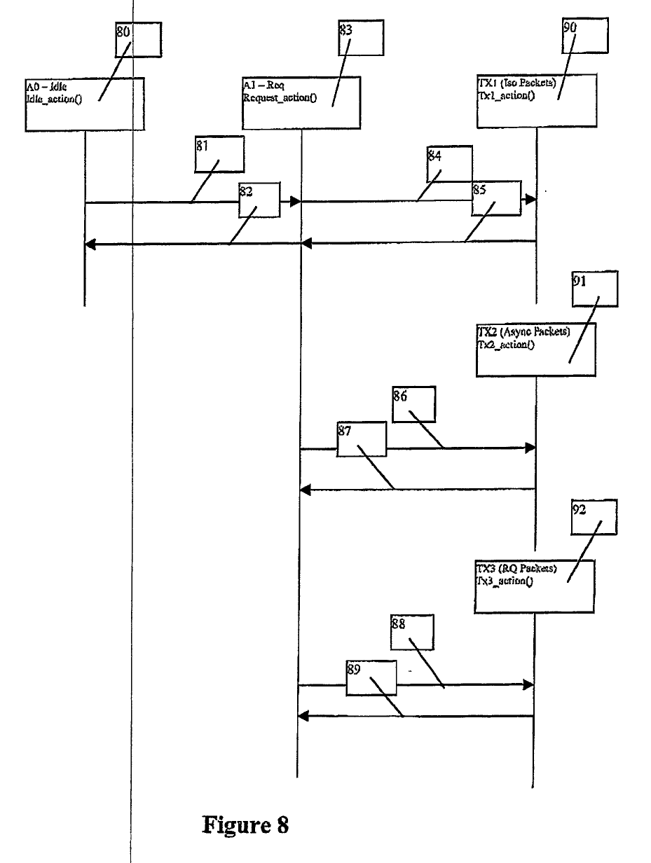

Packets arriving at the switching device 20 are routed to one of the switches output ports according to a routing table, stored in the output port memory queues and wait until selected to be forward by a concentrator block 23. The concentrator block 23 is a state machine electronic circuitry managed by a switch processor that is responsible for selecting and forwarding the data either to a connected IEEE1394 portal or to another switch. The concentrator block is responsible for selecting packet to be forwarded from the output ports. The operation of the concentrator block 23 is described in more detail below with reference to FIG. 8.

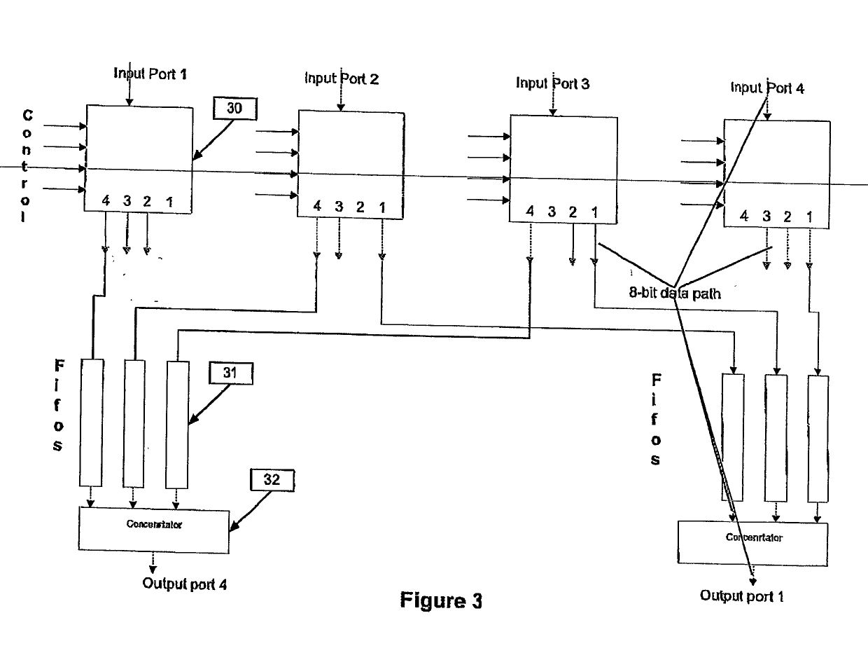

Each layer 22 has a switching circuitry, an example of which is illustrated in the schematic diagram of FIG. 3.

The switching layer 22 has four switches 30, each having an 8-bit data path. A primary packet forwarded to the switching layer 22 will be arrive at the switch 30 that is associated with the packet's originating input port. Each switch 30 directs received data packets to one or more of the output ports. A switch 30 may direct data to none of the output ports, to all of the output ports (broadcast) or to any selective combination. Switch operation is controlled by control bits and is done as part of a switched fabric protocol by a switch processor. However, a switch 30 will never direct a packet to the output port adjacent to the switch input port (input port K will never write to output port K).

Each output port has a FIFO memory 31 linked to each switch 30. Data coming simultaneously from more than one input port will be written simultaneously because they are directed to different FIFO memories 31. A concentrator 32 linked to the FIFO memories of an output port aggregates all packets coming from all layers and all input ports (except obviously the adjacent input port). The concentrator 32 is the gateway between the output port memory and the CIO 13.

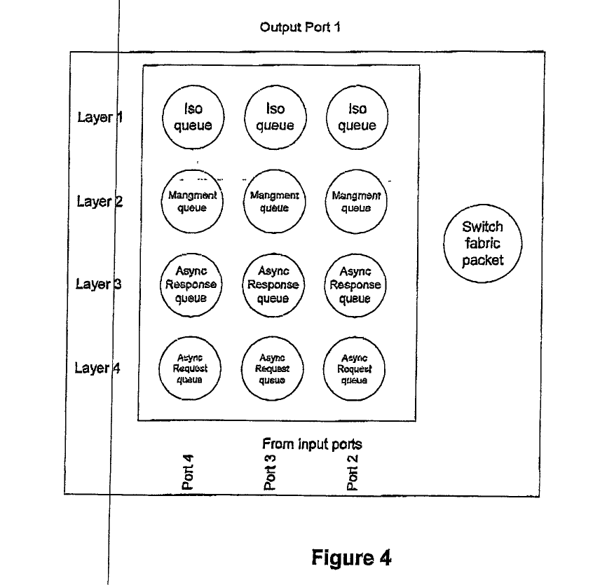

FIG. 4 illustrates a single output port queue arrangement used in the present invention. The illustrated output port is the first outbound port therefore it accumulates only input ports 2, 3 and 4. The packets are sorted in different queues forming a matrix as is shown in FIG. 4. Many configurations are possible for implementing the queue memory, for example a queue may be maintained by FIFO memory or a shared multi port memory with pointer management in the switch processor. In addition a small FIFO is maintained for switch fabric packets. Switch fabric packets are used to negotiate the transmission path of primary IEEE1394 packets. For an outbound port K the switch fabric packet are directed to inbound port K. Such packets are then routed in the switch to the switch fabric packet FIFO.

As can be seen in FIG. 4 the layer arrangement is selected in this example to be:

| | |
|---|---|
| First Layer | Isochronous messages. |
| Second Layer | Management messages. |
| Third Layer | Asynchronous response messages. |
| Fourth Layer | Asynchronous request messages. |

However, any other arrangement may be selected without effecting operation of the switch according to the present invention. Switch fabric packets are given the highest priority by the concentrator and is always forwarded before any other packet.

The flow of data packets in a network incorporating a switch according to the present invention will now be described. Packet flow is automatic without requiring management intervention. Packet flow is performed by a hop-to-hop negotiation protocol. Packets originated from a bus with a remote bus destination are read by a portal on the bus responsible for directing the packets to the switch fabric. Portals are also the point on a bus at which packets from remote destinations are received from the switch fabric. A portal has a processor that can perform packet operations. The portal packet operations may be done before forwarding the packet to the switch fabric, or after receiving the packet from the switch fabric and before transmitting the packet over the destination bus. The switch fabric does not perform any primary packet operation.

Before forwarding a packet to the switch fabric, a portal encapsulates the packet with a header quadlet (32 bit computer word) and a trailer quadlet. The header may include the following fabric elated information: packet size, routing address, packet type, and request response field. The trailer includes data for error detection. Information in a header is used to generate an associated switch fabric packet. The switch fabric packet and its generation is described in detail below with reference to the RQRS protocol.

The data flow is controlled by:

An output port state machine;

The RQRS protocol;

The MLIP protocol; and,

The concentrator.

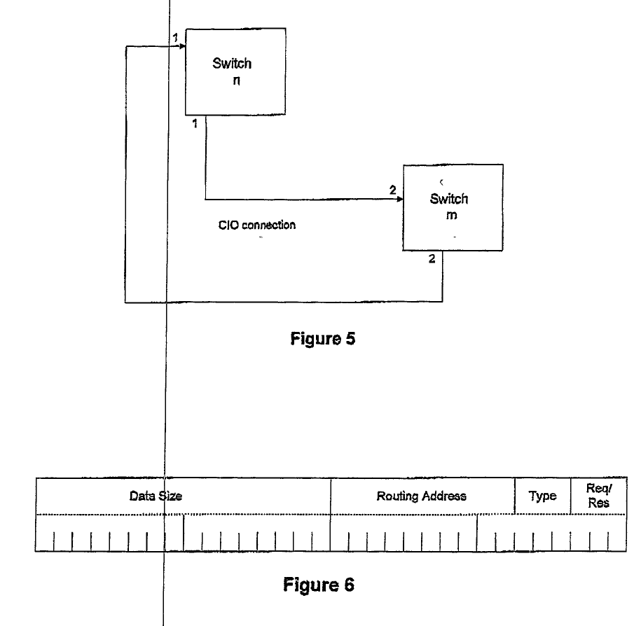

FIG. 5 is a channel input output local loop demonstrating fabric request packet flow. The flow of he switch fabric packet is a loop over the CIO. A switch fabric packet originated by switch n output port 1 is referred to hereafter as a fabric request packet. The fabric request packet is forwarded to switch m port 2. Switch m input port 2 processes the request utilizing the switch processor, the outcome of this process is a fabric response packet. Because the request was received on port 2 the response will be forwarded to output port 2. The fabric packet is received on switch n port 1 and forward to the output port 1 to complete a full cycle. In similar way, a request packet can be originated in switch m at port 2. The same applies also to connections between a switch and a portal.

An output port generates a fabric packet locally and after completion of a full cycle the same output port discard it. A fabric packet will be returned to its originator on the same CIO that transmitted it.

As is illustrated, connections are point to point and the output port number used for fabric packets is always coupled and adjacent to the input port number used (in switch n input and output port 1, in switch m input and output port 2). Fabric packets are generated and passed to negotiate the transmission of IEEE1394 packets. A fabric response may be grant or denial of the packet flow. Grant or denial of packet flow is determined in dependence on the status of the destination queue and whether the queue has sufficient storage space.

If a portal negotiating an asynchronous primary packet receives a denial it will prevent the requesting output port from sending the packet, and the packet remains in storage. If the portal keeps receiving getting packets there is a risk for queue to become full. In the event of portal queue becoming full, the portal link layer will return an ‘ack_busy’ (as define in IEEE1394 clause 6.2.5.2.2) and discard the incoming bus packet.

The isochronous packet bandwidth network allocation process guarantees that no isochronous queue will ever become congested.

FIG. 6 is a schematic diagram illustrating a fabric request packet format. A request packet is a two-quadlet packet consisting of the packet header and an inverse quadlet used for detecting errors.

The packet header quadlet has the following fields:

Packet Size.

Routing address.

Packet type.

Request/response field.

The routing address is an address to a routing table. The data retrieved from the table defines the target output port or ports for the packet.

Packet Type has the following values:

Isochronous

Management

Asynchronous Response

Asynchronous request

Req/Res has the following values:

IEEE-packet=0.

Request packet=1.

Response packet grant=2.

Response packet deny=3.

Management-packet=4.

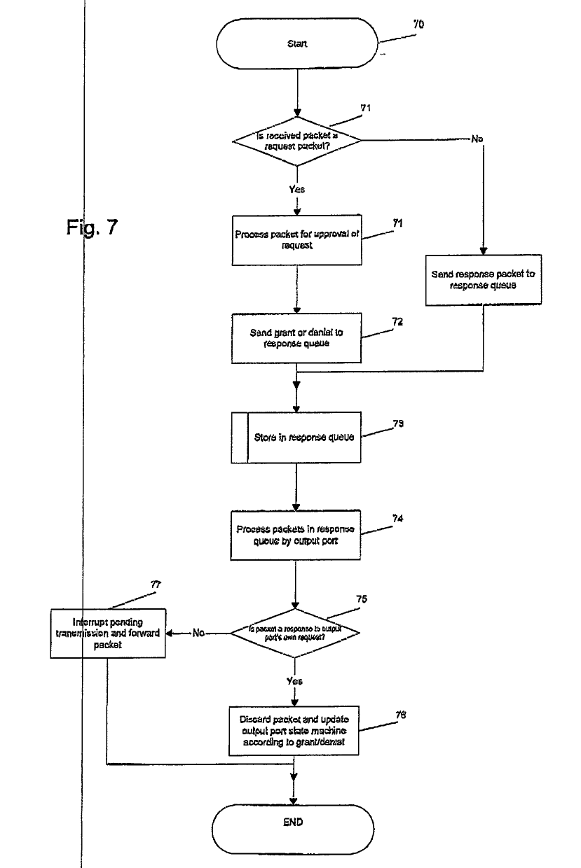

FIG. 7 is a flow chart illustrating the operation of the RQRS protocol. When an output port needs to forward a primary packet it creates a fabric request packet based on the primary packet header and sends it to the adjacent input port in step 70. The input port may receive either a fabric request packet or a fabric response packet generated earlier by the said switch output port. The packet type is determined in step 71. If the packet is a request the switch processor processes it in step 72 and the response is forwarded to the output port response queue in step 73. Otherwise, if the packet is a response it is forwarded to the response queue in step 73 without processing to complete a full cycle.

The output port reads packets from the response queue in step 74 and checks if the packet is a response to an earlier request generated by itself in step 75. If this is the case the packet is discarded and the output port is updated according to the response (either grant or denial) in step 76. Alternatively, if the fabric packet is not a response, the packet must be a response that was generated by the input port to a remote adjacent switch request. In this case the output port will forward the corresponding packet at the highest priority level in step 77.

The MLIP (multi-layer interrupt protocol) enables the sharing of the switch fabric interconnections (CIO) between the asynchronous, isochronous and switch fabric packet types.

While a switch output port is transmitting a packet it is still able to receive information from the input ports. This information will interrupt the current transfer in the following cases:

A fabric response packet has arrived (in full) and the time to finish the current transfer is larger than a programmable parameter (TINT) that prevents the interrupt if the current transferred packet is small or most of it already been sent. The interrupt process introduces a certain overhead in the system flow therefore the justification for the above. An isochronous packet has arrived (in full) while an Asynchronous packet is being transferred and time to complete the current transfer is larger than TINT. A transfer that is interrupted is placed in a memory so it can be continued once the interrupting packet has been transferred.

If a decision in the output port has been made to interrupt the current transfer a control character is sent. While receiving a packet, the adjacent input port is monitoring the incoming packet. If a packet is terminated before its size reaches the header size it means that the packet was interrupted the input port will stack all the necessary state parameter so it will be able to continue the transfer from the point it was stopped. The output port then starts the transmission of a fabric request packet and following a fabric routing path grant it transmits the interrupting packet. Once the transfer is complete, the interrupted transmission is resumed from the point it was interrupted (only the remaining data not sent before will be transmitted).

The interrupt mechanism may be nested, that is, an isochronous packet may interrupt an asynchronous packet and the isochronous packet may itself be interrupted by a fabric response waiting for the adjacent remote port.

FIG. 8 is a schematic diagram illustrating the operation of the output port state machine. The idle state A0 (80) is the state in witch the output port is waiting for a complete packet to be stored in the output port memory. The switch controller is monitoring all the queues. If a queue is identified that is not empty and the packet is not denied than state in step 81. If a packet in a queue is encountered that has been denied before, the time since the denial is checked by sampling the switch clock. If the time from packet denial is larger than a predetermined parameter TDENY then its denial bit status is reset. When transmission of a packet is completed and there is no interrupted packet waiting for completion of transmission the state machine returns to the idle state A0 in step 82. If there is more than one packet waiting in the output port memory, a packet is selected according to the concentrator logic described in detail below.

The request state A1 (83) is an intermediate state. After selecting a primary packet to be forwarded, a switch fabric request packet is generated. The state machine then moves in step 88 to the state TX3 (92) for transmitting the request to the adjacent port. After the request packet ha been sent we return in step 89 to the state A1 (83). In state A1 (83 ) we wait for a response to be received. Because this type of packet has the highest priority it will interrupt any other communication therefore the response packet must be returned in a short time. If a response package is tardy and exceeds a predetermined timeout, TREQ, the request response session is aborted and the primary packet associated with it is discarded (usually a tardy response indicate a connection failure). When a response has been returned it is checked. If the request has been denied it records the current clock time and associates this record with the primary packet. The state machine then returns to state A0 (80). If the request has been granted, the state machine moves in step 84 to state TX1 (90) if the primary packet is an isochronous packet or in step 86 to state TX2 (91) if the primary packet is an asynchronous packet. In step TX1 or TX2, the primary packet is transmitted. After returning from state TX1 (90) or state TX2 (91) to state A1 (83) in steps 85 or 87 respectively, the state machine checks if there is an interrupted packet in which case it resumes the interrupted transmission by moving again to state TX1 (90) or TX2 (91).

While in state TX1 (90) and TX2 (91), the port memory is still receiving data from the input ports. In the event of a complete package arrival to the port memory the switch controller will determine if the current transfer has to be interrupted. Upon such an event the state machine returns to state Al (83) and starts negotiating a new packet transfer by sending another switch fabric request packet.

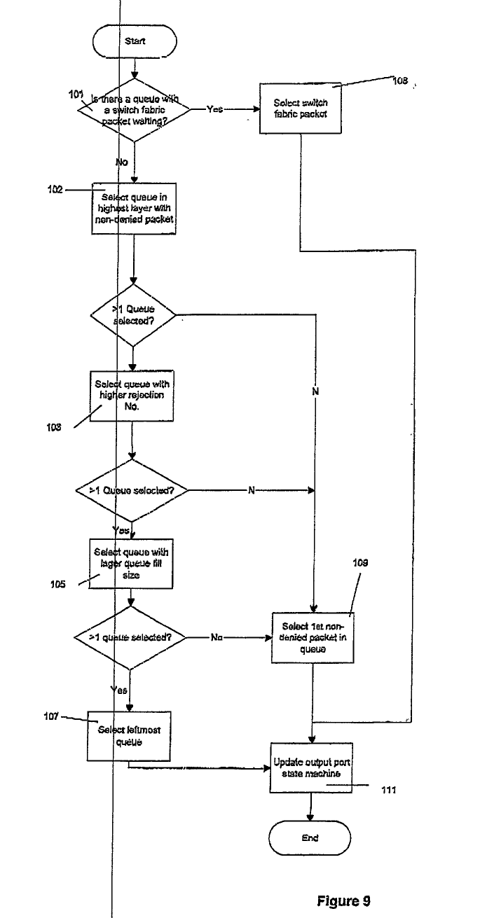

FIG. 9 is a flow chart illustrating the operation of an output port concentrator algorithm. It is common to have more than one packet at the output port memory. The concentrator therefore selects the next packet to be transmitted.

The concentrator algorithm starts in step 100 each time a packet arrives to the output port memory in full, or after a previous selected packet is denied.

A selected packet is referred to below as a contender packet and will be transferred only after positive completion of a preliminary negotiation step with the destination switch or portal. If the negotiation succeeds then the switch fabric starts transmitting the packet. Otherwise, if it is denied, the system starts the concentrator process again in order to select a new contender packet.

In addition to the queue location in the output matrix as described in FIG. 4, two further parameters are used for each of the queues:

The queue size, this reflects the amount of the queue memory in use (the queue may hold several packets).

Queue rejection number, each time another queue is selected and the queue is not empty this number is incremented. If the queue has been selected and the packet (head packet) transmission was granted then the queue rejection number is reset.

In step 101, if a switch fabric response packet is detected in the switch fabric queue it is selected for transmission in step 108. Higher output queue layers (1 is higher than 2 in the illustrated examples) always has overriding priority over lower output queue layers. In step 102 the queue of the highest output layer that has at least one packet that is not denied is selected. This means that no matter how any asynchronous packet have been accumulated in queues, as long as there is a queued isochronous packet it will always go first. After selecting the highest layer, if more than one queue of the same layer has a packet, each queue's rejection number is examined. The queue with the higher rejection number is selected in step 109. If more than one queue has the same highest rejection number, the queue size is examined in step 105 and a packet from the queue with the higher queue size selected in step 110. However, if, after selecting a layer and examining rejection numbers and a queue's size, there is still a tie, the leftmost queue is selected in step 107.

After selecting a packet, the output state machine is updated in step 111 and the negotiation RQRS protocol is started. If a packet is being transferred during the selection of a new packet a decision must be made if it is necessary to interrupt the current transfer, as described above.

If an asynchronous packet receives a denial, if the connection is from a switch output port to a portal input port no additional action is taken. However, in all other cases a queue rotation is performed. This means that the first packet in queue will be moved to the end of queue in a cyclic manner (second packet will become first) in order to prevent blockages.

While the invention has been described with respect to a limited number of embodiments, it will be appreciated that many variations, modifications and other applications of the invention may be made.

In the method claims that follow, alphabetic characters used to designate claim steps are provided for convenience only and do not imply any particular order of performing the steps.

1. A method for routing data packets through a switch fabric said switch fabric connecting a plurality of broadband buses, said switch fabric containing a plurality of switches each with several ports and having interconnections between them, said switch fabric being connected to said buses using portal devices, the method comprising:
(a) connecting the switches in a three-dimensional architecture providing horizontal data routing according to addresses and vertical data routing according to packet types;
(b) executing an allocation procedure to manage the bandwidth resources of said fabric resulting with assigning routing tables at the switches and portals;
(c) encapsulating packets prior to forwarding to the switch fabric; and,
(d) executing a hop-by-hop packet flow through said switches of said switch fabric said packet flow controlled by an output port having an output port state machine and an output port concentrator.
The switch fabric may be a single component or constructed from a number of components.

2. A method according to claim 1, wherein packet flow is controlled by said output port state machine, a RQRS protocol and a MLIP protocol.

3. A method according to claim 2, further comprising: executing a RQRS protocol for negotiating a primary packet transfer, said RQRS protocol comprising the steps of:
(a) selecting at a switch output port a primary packet to be transferred and generating a fabric request data packet;
(b) transferring, the fabric request packet over the switching fabric to an adjacent input port;
(c) determining acceptability of the fabric request and generating a fabric response packet indicating grant or denial of the request; and,
(c) transmitting said fabric response packet back to the originating switch and inputting the denial or grant of said selected packet to the output port state machine.

4. A method according to claim 2, further comprising: executing said MLIP protocol for sharing a connection, CIO, between a plurality of packets, said MLIP protocol comprising the steps of:
(a) receiving data at input ports while transmitting a packet;
(b) checking for interrupt conditions while transmitting the packet;
(c) in the event of interrupt conditions, ceasing transmission of the current packet, transmitting a control character indicating end of transmission, storing necessary data needed to subsequently resume the transmission, and starting negotiating a new packet transfer under said RQRS protocol; and
(d) upon ending a packet transmission, checking if an interrupted packet is awaiting completion and resuming transmission of any interrupted packet.

5. A method according to claim 4, the output port concentrator selecting the next packet to be forwarded from the output memory, comprising:
(a) selecting a new packet to be transferred if:
(i) said output port is in idle state and at least one packet is ready for transmission; and
(ii) said output port is currently in transmission state while a new packet has arrived in full, and interrupt conditions are met;
(b) selecting the packet to be transferred according to parameters selected from the group including layer priority when higher layer equals higher priority, a rejection number, a queue size, and natural priority; and
(c) starting said RQRS protocol process utilising a switch timer for the management of said selected packet's denials.

6. A program storage device readable by a machine and encoding a program of instructions for executing the method steps of claim 1.

7. A computer readable medium on which is stored a computer program of instructions for controlling a general purpose computer to route data packets in a switch fabric between a plurality of broadband buses, the switch fabric containing a plurality of switches each with several ports and having interconnections between them, the switch fabric being connected to said buses using portal devices, comprising in combination:
means for connecting the switches in a three-dimensional architecture providing horizontal data routing according to addresses and vertical data routing according to packet types;
means for executing an allocation procedure to manage the bandwidth resources of said fabric resulting with assigning routing tables at the switches and portals;
means for encapsulating packets prior to forwarding to the switch fabric; and,
means for executing a hop-by-hop packet flow through said switches of said switch fabric; and,
means for controlling packet flow from an output port with an output port state machine and an output port concentrator.

8. A computer readable medium according to claim 7, further comprising means for controlling packet flow by said output port state machines a RQRS protocol and a MLIP protocol.

9. A computer readable medium according to claim 8, further comprising means for executing a RQRS for negotiating a primary packet transfer, comprising:
means for selecting at a switch output port a primary packet to be transferred and generating a fabric request data packet;
means for transferring the fabric request packet over the switching fabric to an adjacent input port;
means for determining acceptability of the fabric request and generating a fabric response packet indicating grant or denial of the request; and,
means for transmitting said fabric response packet back to the originating switch and inputting the denial or grant of said selected packet to the output port state machine.

10. A computer readable medium according to claim 8, further comprising means for executing said MLIP protocol for sharing a connection, CIO, between a plurality of packets, comprising:
means for receiving data at input ports while transmitting a packet;
means for interrupting current data transfer upon detection of interrupt conditions;
means for ceasing transmission of the current packet, transmitting a control character indicating end of transmission, storing necessary data needed to subsequently resume the transmission, and starting negotiating a new packet transfer under said RQRS protocol; and
means for upon ending a packet transmission, checking if an interrupted packet is awaiting completion and resuming transmission of any interrupted packet.

11. A computer readable medium according to claim 7, the output port concentrator selecting the next packet to be forwarded from the output memory, comprising:
means for selecting a new packet to be transferred if:
(i) said output port is in idle state and at least one packet is ready for transmission; and
(ii) said output port is currently in transmission state while a new packet has arrived in full, and interrupt conditions are met;
means for selecting the packet to be transferred according to parameters selected from the group including a layer priority when higher layer equals higher priority, a rejection number, a queue size, and natural priority; and
means for starting said RQRS protocol process utilising a switch timer for the management of said selected packet's denials.

12. A switching fabric comprising a three-dimensional architecture providing horizontal data routing according to addresses and vertical data routing according to packet types, the switch fabric including a plurality of input and output ports for connection to a bus or other network traffic carriers.

13. A switching fabric according to claim 12, wherein output ports of at least some of the switches are connected to an input port of another switch to form the three-dimensional architecture.

14. A switching fabric according to claim 13, wherein each switch has a numeric identifier n, wherein the nth input and output of the switch is reserved for transmission and receipt of switch fabric routing-packets.

15. A switching fabric according to claim 12, further comprising a concentrator connected to at least some of the output ports of at least some of the switches, the concentrator being arranged to select the next packet to be forwarded from the output ports to exit the switching fabric.

16. A data communications network including a switching fabric system inter-connecting a plurality of buses and facilitating inter bus isochronous and asynchronous data communication, the plurality of buses being connected to said switching fabric via portal devices, the switching fabric comprising a plurality of switches interconnected by a three dimensional array of CIO connections, the network further comprising a network management node for data flow control for transferring packets from one of said buses to at least one of a plurality of said buses, thereby enabling unicast, multicast and broadcast of data packet transfer.

17. A network according to claim 16, wherein each of said switches is a three-dimensional switch having an output port memory organization to support said inter-bus data communication.

18. A network according to claim 16, wherein each bus is a multimedia broadband bus of the IEEE1394 type.
